(19) United States
(12) Patent Application Publication
(10) Pub. No.: US 2004/0124228 A1
(43) Pub. Date: Jul. 1, 2004

(54) Method for testing soldering quality

(76) Inventor: Hwan-Chia Chang, Taichung (TW)

Correspondence Address: SHOEMAKER AND MATTARE, LTD, 10 OST OFFICE ROAD - SUITE 110, SILVER SPRING, MD, 20910, US

(21) Appl. No.: 10/691,961

(22) Filed: Oct. 24, 2003

(30) Foreign Application Priority Data
Oct. 25, 2002 (TW) 091125169

(51) Int. Cl. B23K 31/12

(52) U.S. Cl. 228/103; 228/104

(57) ABSTRACT

A method for testing soldering quality is provided for determining the solder quality of pins, leads, a connector or an electronic component mounted on a circuit board. A soldering contact, soldered to the circuit board, is enclosed by melted solder during soldering and generate a different color from that before soldering. The color difference allows the soldering quality of the soldering contact to be determined by visual inspection and prevents inferior products from entering subsequent fabrication processes, thereby improving the soldering reliability.

### FIELD OF THE INVENTION

The present invention relates to testing methods, and more particularly, to a method for testing and determining the quality of soldering between a circuit board and contacts such as pins, leads or connectors of electronic components which are mounted on the circuit board.

### BACKGROUND OF THE INVENTION

In order to minimize wiring jobs among different parts and for a goal of electrical integration, a variety of electronic components such as active and passive devices, e.g. integrated circuit (IC), diode, resistor, capacitor, transistor, and connector, after being assembled or packaged, usually need to be mounted on a huge printed circuit board (PCB) such as motherboard, so as to allow the electronic components to perform their expected electrical functions. Generally, there are many methods applicable for assembling the electronic components on the PCB, among which a lead soldering technique is currently the most widely used in concern of product popularity and market direction.

A conventional lead soldering technique uses leads of the electronic components as electrical connections which are mounted on the PCB to electrically connect the electronic component to the PCB. This technique involves plugging ends of the leads of the electronic components in predetermined positions on a surface of the PCB, followed by coating the surface of the PCB with solder flux. Then, a wave soldering process is performed during which the surface of the PCB is immersed with melted solder. After that, the lead ends are completely encapsulated by the melted solder by a high temperature soldering process. As the soldering process is complete, the electronic components are visually inspected to discard inferiors with poorly soldered joints and then undergo electrical tests by a test machine.

Conventionally, the leads of the electronic components are required being plated with tin prior to soldering. As the plated tin and the melted solder both have substantially the same silver color, during the visual inspection of the soldered electronic components, the inferiors with poorly soldered joints cannot be easily detected and as a result are undesirably subject to subsequent processes. Furthermore, since the leads have substantially the same appearance before and after soldering, therefore more detailed visual inspection is usually required for checking the soldering quality of the leads and thus prolongs the testing time.

In light of the problems described above, a X-ray scanner is used in place of visual inspection to check the soldered products. However, the use of the X-ray scanner would increase the equipment costs, and the time for scanning causes elongates the production schedule which is detrimental to mass production. Therefore, it is greatly desirable to develop a method for testing the soldering quality of electronic components which can cooperate with manual operation.

### SUMMARY OF THE INVENTION

An objective of the present invention is to provide a method for testing soldering quality, whereby a color difference is produced before and after soldering operation to allow inferior products with defective soldering quality to be easily detected by visual inspection.

Another objective of the present invention is to provide a method for testing soldering quality, whereby inferior products with defective soldering quality can be discarded in a soldering stage and are not allowed to undergo subsequent fabrication processes.

A further objective of the present invention is to provide a method for testing soldering quality, whereby inferior products are easily inspected by vision, thereby reducing fabrication costs and assure product reliability.

In accordance with the foregoing and other objectives, the present invention proposes a method for testing soldering quality between an electronic component and a circuit board where the electronic component is soldered. First, at least one electronic component and a printed circuit board (PCB) for carrying the electronic component are prepared, wherein leads of the electronic component have a first color. Then, the electronic component is soldered on the PCB during which the leads are changed from the first color to a second color that can be inspected visually or visualized by irradiation of a specific light source.

Comparing with the prior art in which the soldering performance is not easily determined from the appearance of the soldered leads, the testing method according to the invention involves forming a soldering portion at an end of each lead of the electronic component and changing the color of the soldering portion before and after the soldering process to produce a color difference which can be observed by visual inspection or specific light irradiation. For example, before soldering, the soldering portion is made of a nickel alloy material having a dark black color referred to as the first color. During soldering, melted solder or solder flux is applied on predetermined area of the PCB for connecting the electronic component and covers the soldering portion which thus shows a silver color, referred to as the second color, of the melted solder or solder flux. However, in the case of the solder portion not perfectly soldered to the PCB while exposing a part of the first color or dark black color, it indicates failure in soldering. Therefore, the color difference allows the solder portions of the leads to be visually inspect to determine the soldering quality between the electronic component and the PCB once the soldering process is complete, so as to detect inferior products with defective soldering reliability in the soldering stage and prevent the inferior products from entering subsequent fabrication processes.

In another embodiment of the invention, the solder portions of the leads are irradiated with a specific light source such as ultraviolet, laser, etc. and then subject to visual inspection. In particular, before soldering, the soldering portion is irradiated to show the first color; after soldering, the soldering portion is covered or interacts with solder to show the second color under irradiation, so as to allow soldering quality between the electronic component and the PCB to be determined by the color difference of the soldering portions of the leads.

### BRIEF DESCRIPTION OF THE DRAWINGS

The present invention can be more fully understood by reading the following detailed description of the preferred embodiments, with reference made to the accompanying drawings, wherein:

FIG. 1 is a flow diagram showing procedures of a method for testing soldering quality according to a first preferred embodiment of the invention;

FIG. 2A is a schematic diagram showing an electronic component used in the method for testing soldering quality according to the invention;

FIG. 2B is a schematic diagram showing formation of lead soldering portions of the electronic component in the method for testing soldering quality;

FIGS. 3A and 3B are schematic diagrams showing cross-sectional views of the electronic component being soldered to a printed circuit board;

FIG. 4 is a flow diagram showing procedures of a method for testing soldering quality according to a second preferred embodiment of the invention;

FIG. 5A is a schematic diagram showing an elevation view of a connector subject to the method for testing soldering quality; and

FIG. 5B is a schematic diagram showing a cross-sectional view of FIG. 5A taken along line 5B-5B.

### DETAILED DESCRIPTION OF THE PREFERRED EMBODIMENTS

First Preferred Embodiment

A method for testing soldering quality proposed by the present invention is applied to pins, leads, active/passive devices such as packaged integrated circuit (IC) with semiconductor chip (e.g. large-scale integration chip), resistor, capacitor and diode, as well as connectors, which are electrically connected to a printed circuit board (PCB) and observed from a color change in appearance to determine the soldering quality between soldering ends and the PCB.

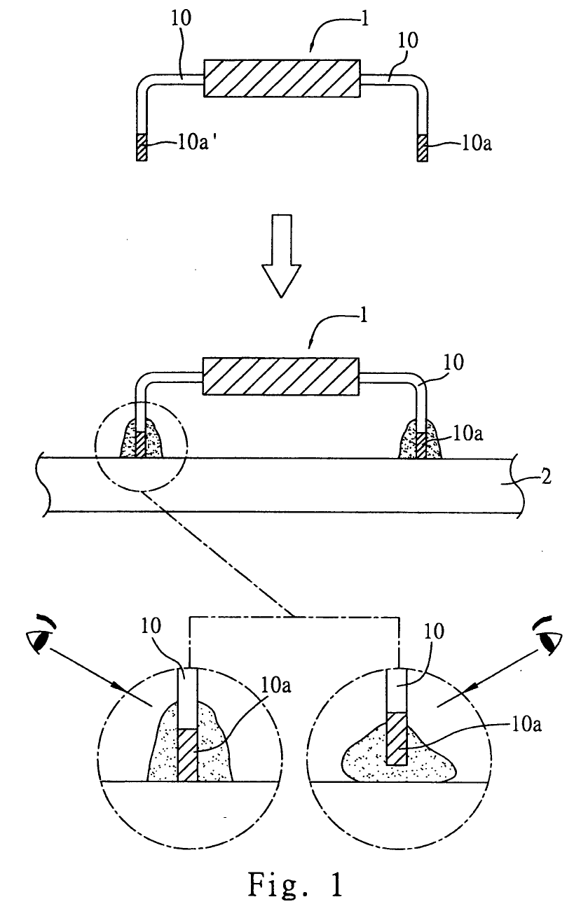

As shown in FIG. 1, at least one row of leads 10 and a PCB 2 (such as motherboard) for carrying the leads 10 are provided, wherein the leads 10 are soldered to the PCB 2 solely or in connection with an electrical component such as resistor, capacitor or transistor, to form an electrical coupling between the leads 10 and the PCB 2. The leads 10 may be equivalently replaced with pins. Notwithstanding, in this embodiment, “lead” is designated with a different definition from “pin”. Lead is a connection contact that can be plugged in or soldered to the PCB 2 by using Surface Mount Technology (SMT) or solder bath, while pin is an exposed portion of a lead incorporated with a leaded semiconductor package, such as dual inline package (DIP), quad flat package (QFP), small outline package (SOP), and pins grid array (PGA) package, with a lead frame serving as a chip carrier.

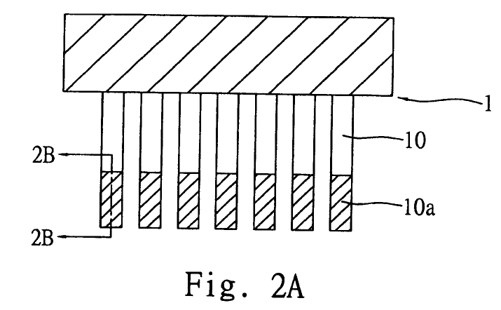

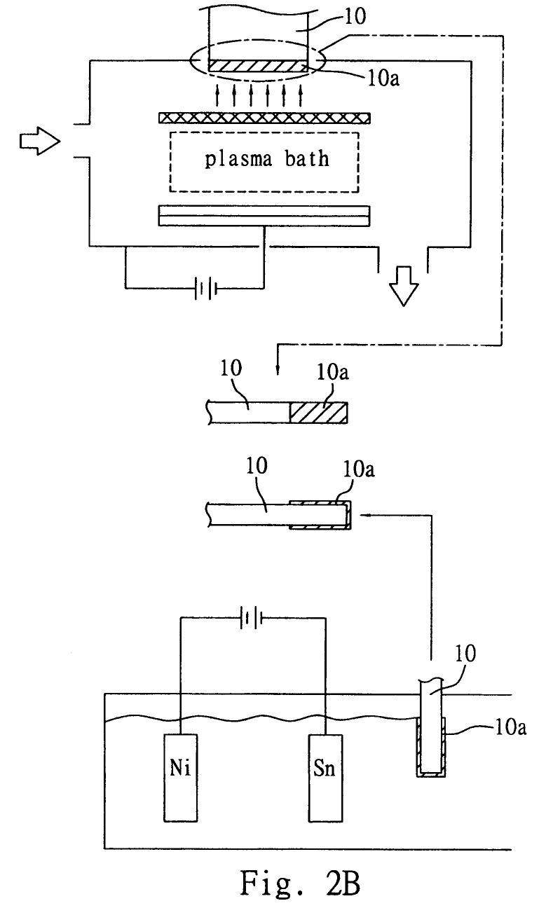

Since the leads or pins, solely or in connection with the electronic component such as IC, resistor or capacitor, are soldered on the PCB 2 via projecting connection leads whose ends are referred to as soldering portions 10a connected to the PCB 2 as shown in FIGS. 1, 2A and 2B. The soldering portions 10a can be formed by an electroplating, electrocoating, plasma welding, or color coating technique, etc.

As shown in FIGS. 2A and 2B, the soldering portion 10a is made of a coating material selected from the group consisting of nickel, nickel alloy, copper, copper alloy, silver, silver alloy, bismuth, bismuth alloy, rhodium, rhodium alloy, ruthenium, ruthenium alloy, zirconium, zirconium alloy, chromium, chromium alloy, titanium, titanium alloy and other metal alloy. After a surface of the connection lead 10 is stripped off a metal oxide layer and dried, the coating material is deposited on an end of the lead 10 by an electrolytic plating or non-electrolytic plating technique such as evaporation, sputtering, dipping, spraying or electrocoating, making the end of the lead 10 or soldering portion 10a coated with the coating material appear in a dark black color and differ from other parts of the lead 10 soldered with tin having a silver color to thereby form a remarkable color difference. It should be understood that the soldering portion 10a may be colored differently in accordance with the use of different coating materials. Besides the dark black color, the soldering portion 10a may have a color of black, red, yellow, blue, green, orange, purple, etc. without particular limitation except for producing obvious color contrast as described above.

On the other hand, besides producing the above color difference, an extending soldering portion 10a may be formed on the end of the lead 10 by a plasma deposition, physical deposition, or chemical deposition technique. Alternatively, the soldering portion 10a of the lead 10 can be coated with a staining material by a staining or coloration technique. As these techniques are well known in the art, no further description thereto is here provided.

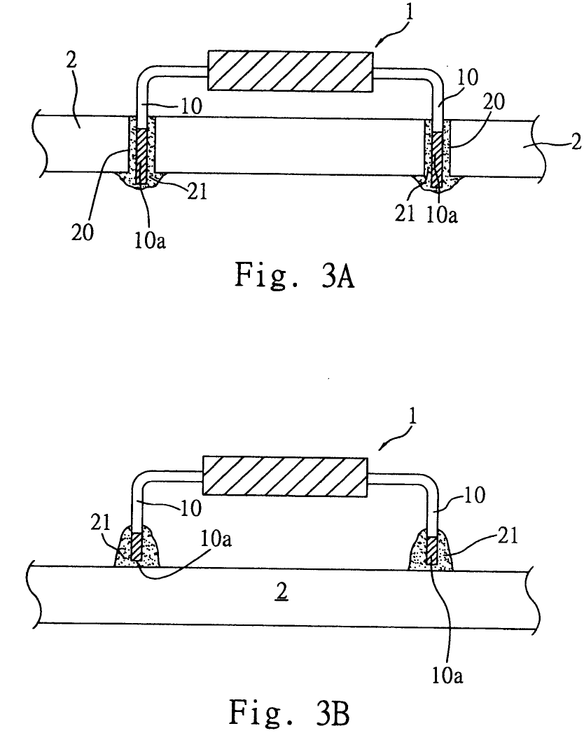

By completing the fabrication of the soldering portions 10a of the leads 10 for an electronic component 1, as shown in FIGS. 1 and 3A, the leads 10 are soldered to predetermined locations on the PCB 2 to electrically connect the electronic component 1 to the PCB 2. The electronic component 1 is mounted on the PCB 2 by conventional Through Hole Mounting Technology (THT/TMT) or Surface Mount Technology (SMT). FIG. 3A shows the use of THT/TMT to plug the leads 10 of the electronic component 1 in corresponding vias 20 through the PCB 2. Melted solder 21 (such as silver melted tin) is applied over a surface, not for mounting the electronic component 1, of the PCB 2 and encapsulates the soldering portions 10a of the leads 10, thereby making the soldering portions 10a change from a dark black color before soldering to a silver color after being soldered to the PCB 2, such as the soldering quality between the leads 10 of the electronic component 1 and the PCB 2 can be determined according to the color change. Similarly, as shown in FIG. 3B using SMT for mounting the electronic component 1 on the PCB 2, a conventional technique such as spraying and plasma coating is employed to apply the melted solder 21 on the predetermined locations of the PCB 2 to cover the soldering portions 10a of the leads 10 and strongly solder the leads to the PCB 2, which also allows the soldering portions 10a of the electronic component 1 to change color thereof before and after soldering.

Besides the above use of melted solder 21 to produce the color change of the soldering portions 10a of the leads 10, a coloring substance (not shown) can be chemically mixed with the melted solder 21 or solder flux (not shown) to allow the soldering portions 10a to react with the coloring substance and change color thereof during a reflow soldering process. As a result, the leads 10 of the electronic component 1 similarly appear in different colors before and after soldering, and the soldering quality between the electronic component 1 and the PCB 2 can be easily determined by visual inspection according to the color difference.

Second Preferred Embodiment

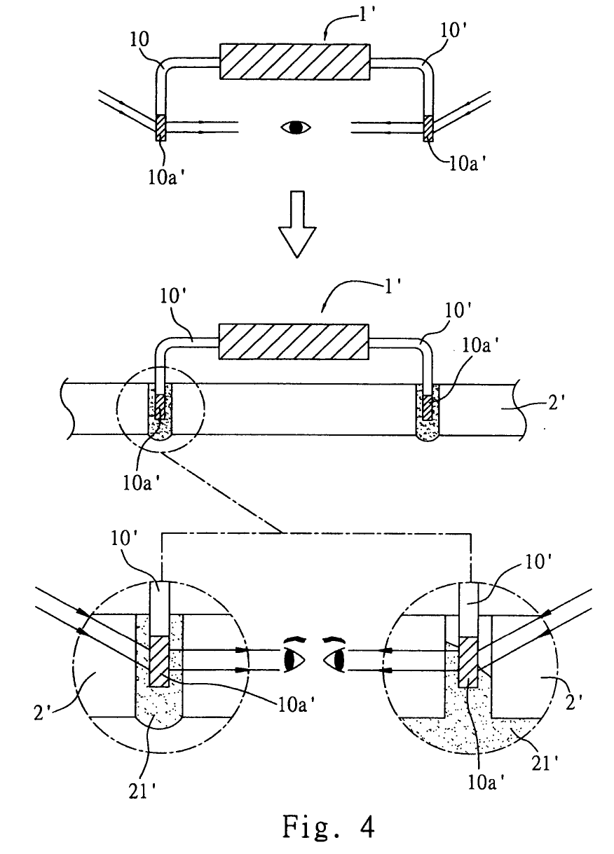

FIG. 4 illustrates procedures of the method for testing soldering quality according to a second preferred embodiment of the invention. As shown in the drawing, the method of this embodiment is mostly the same to that of the above first embodiment, with a difference in that the soldering portions 10a′ of the leads 10′and the melted solder 21′ in the second embodiment are inspected by the reflection from specific irradiation such as ultraviolet or laser. In this embodiment, before soldering, the soldering portions 10a′ of the leads 10′ are irradiated with ultraviolet and reflected to show a dark purple color. And after soldering, the soldering portions 10a′ covered with the melted solder 21′ reflect and show a purplish red color under ultraviolet irradiation. As a result, the soldering quality between the electronic component 1 and the PCB 2 can be determined by inspecting the color of the soldering portions 10a′ of the leads 10′ irradiated with the specific light source.

Third Preferred Embodiment

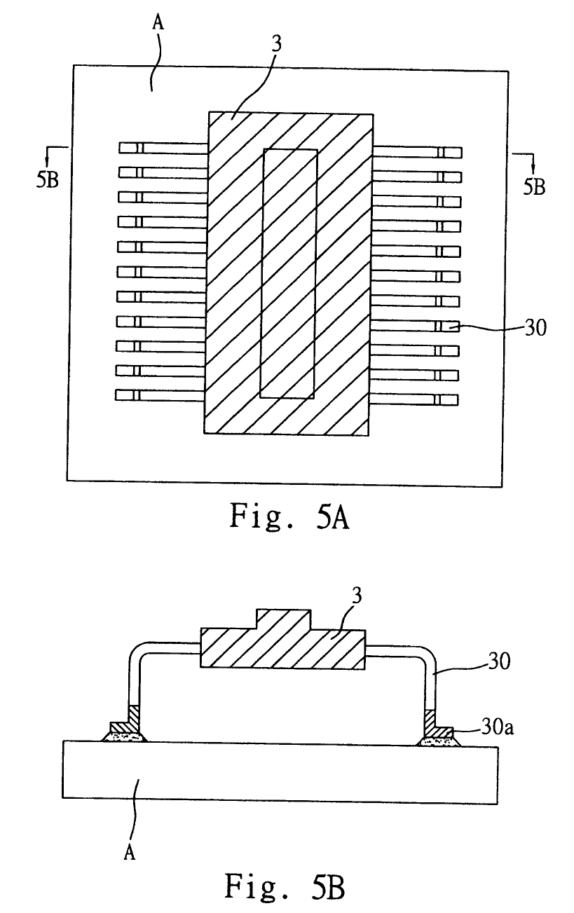

FIGS. 5A and 5B illustrate a connector, for connecting electronic components, subject to the method for testing solder quality according to the invention. As shown in the drawings, the connector 3 has at least one row of projecting plug leads 30. For interconnecting two electronic components A, B such as printed circuit board (PCB) via the connector 3 (only the PCB A is illustrated here), a true connector is soldered via its projecting leads 30 to corresponding solder pads on a PCB A and coupled to a corresponding false connector (not shown) soldered on a PCB B (not shown). As ends or soldering portions 30a of the leads 30 are coated with an organic or inorganic chemical dye, or a deposited metal layer before soldering, or interact with a coloring substance added to solder flux or melted solder, to produce a difference in color of the soldering portions 30a before and after solder, the soldering quality between the connector 3 and the PCB A can be determined from the color difference of the soldering portions 30a of the leads 30.

Therefore, the method for testing soldering quality according to the invention produces a color difference for leads of an electronic component before and after soldering the electronic component to a PCB, and the color difference of the leads can be inspected by visual observation or specific light irradiation to determine the soldering quality between the electronic component and the PCB. As a result, inferior products with defective soldering quality can be collected and discarded during the soldering stage without entering subsequent fabrication processes, thereby reducing fabrication costs and improving soldering reliability of the electronic component.

The invention has been described using exemplary preferred embodiments. However, it is to be understood that the scope of the invention is not limited to the disclosed embodiments. On the contrary, it is intended to cover various modifications and similar arrangements. The scope of the claims, therefore, should be accorded the broadest interpretation so as to encompass all such modifications and similar arrangements.

What is claimed is:

1. A method for testing soldering quality, comprising the steps of:
mounting at least one lead having a first color on a printed circuit board (PCB); and
soldering the lead to the PCB and changing the first color of the lead to a second color so as to produce a color difference for determining the soldering quality.

2. The method of claim 1, wherein the lead is incorporated with an electronic component.

3. The method of claim 2, wherein the electronic component is selected from the group consisting of active device, passive device, semiconductor package, and printed circuit board.

4. The method of claim 1, wherein the lead is formed with a soldering portion by a plasma deposition, physical deposition, or chemical deposition technique to be soldered to the PCB.

5. The method of claim 1, wherein the lead is coated with at least one metallic material selected from the group consisting of nickel, nickel alloy, copper, copper alloy, silver, silver alloy, bismuth, bismuth alloy, rhodium, rhodium alloy, ruthenium, ruthenium alloy, zirconium, zirconium alloy, chromium, chromium alloy, titanium, and titanium alloy, to show the first color.

6. The method of claim 1, wherein the lead is coated with at least one colored layer to show the first color.

7. The method of claim 6, wherein the colored layer is made of a chemical dye.

8. The method of claim 1, wherein melted solder or solder flux is applied on the PCB and covers the lead to show the second color.

9. The method of claim 8, wherein a coloring reagent is added to the melted solder or solder flux.

10. The method of claim 1, wherein the first color is selected from the group of colors consisting of black, dark black, red, yellow, blue, green, orange, and purple.

11. The method of claim 1, wherein the second color is silver or purplish red.

12. The method of claim 1, wherein the second color is observed with visual inspection, or visualized by irradiation of a specific light source.

13. A method for testing soldering quality, comprising the steps of:
connecting at least one connector between two electronic components by projecting leads having a first color of the connector; and
soldering the leads of the connector to one of the electronic components and changing the first color of the leads to a second color so as to produce a color difference for determining the soldering quality.

14. The method of claim 13, wherein the leads are coated with at least one metallic material selected from the group consisting of nickel, nickel alloy, copper, copper alloy, silver, silver alloy, bismuth, bismuth alloy, rhodium, rhodium alloy, ruthenium, ruthenium alloy, zirconium, zirconium alloy, chromium, chromium alloy, titanium, and titanium alloy, to show the first color.

15. The method of claim 13, wherein the leads are coated with at least one colored layer to show the first color.

16. The method of claim 15, wherein the colored layer is made of a chemical dye.

17. The method of claim 13, wherein melted solder or solder flux is applied on the PCB and covers the leads to show the second color.

18. The method of claim 17, wherein a coloring reagent is added to the melted solder or solder flux.

19. The method of claim 13, wherein the first color is selected from the group of colors consisting of black, dark black, red, yellow, blue, green, orange, and purple.

20. The method of claim 13, wherein the electronic component is selected from the group consisting of active device, passive device, semiconductor package, and printed circuit board.
